(19) United States
(12) Patent Application Publication
(10) Pub. No.: US 2024/0352266 A1
(43) Pub. Date: Oct. 24, 2024

(54) WATER-BASED BINDER COMPOSITION AND ITS APPLICATION IN WATER-BASED PRINTING INK

(71) Applicant: BASF SE, Ludwigshafen am Rhein (DE)

(72) Inventors: Yan MEI, Shanghai (CN); Jian Feng XIA, Shanghai (CN); Li LI, Shanghai (CN)

(21) Appl. No.: 18/580,762

(22) PCT Filed: Jul. 6, 2022
(86) PCT No.: PCT/EP2022/068770

§ 371 Date: Jan. 19, 2024

(30) Foreign Application Priority Data
Jul. 23, 2021 (WO) PCT/CN2021/108177

(51) Int. Cl. C09D 11/107; C09D 11/102

(52) U.S. Cl. CPC C09D 11/107; C09D 11/102

(57) ABSTRACT

The present invention is related to a water-based binder composition and its application in water-based printing ink. The binder composition comprises a waterborne poly(meth)acrylate emulsion and a polyurethane. Such composition provides excellent alcohol tolerance, bond strength and resolubility.

### FIELD OF INVENTION

The present invention is related to a water-based binder composition and its application in water-based printing ink.

### BACKGROUND OF THE INVENTION

Packagings such as flexible laminated packaging for food often comprise printed film laminates made of two or more polymeric films which are laminated together and wherein the printing ink resides between two laminated films. The binder for flexible laminated package is synthesized by solvent based technology. However, due to the stricter and stricter regulation on VOC emission, more and more customers need to transfer solvent-based ink to water-based ink. It's important that the ink can have a balanced performance in ink resolubility, blocking resistance, drying speed and good lamination bond strength on various substrates. So far, the existing water-based ink binder in the market usually fails to meet such requirement.

U.S. Ser. No. 10/280,320B2 discloses a lamination printing ink comprising an aqueous polyurethane dispersion binder, pigments, an aqueous carrier and optional additives, wherein the polyurethane is made of polyisocyanates, specific polyesterdiols, polytetrahydrofuran diol, monohydroxy-poly(alkylene oxide), diamino acid compound, polyamine compound and optionally one or more low molecular weight polyols. The lamination printing ink showed improved blocking resistance and improved re-solubility behavior without undue impairing one or more of the other desired requirements.

WO2016202654A1 discloses a printing ink, in particular to a lamination printing ink, comprising at least two binders, at least one pigment, an aqueous carrier and optional additives, wherein one binder is a specific aqueous polyurethane dispersion binder and a further binder is a specific poly(meth)acrylate dispersion binder. The printing ink showed an improved balance of ink resolubility, lamination bond strength and blocking resistance, especially concerning improved ink resolubility and lamination bond strength while maintaining acceptable blocking resistance.

However, none of the abovementioned prior arts disclosed a printing ink that showed a balanced performance in ink resolubility, drying speed and lamination bond strength on various substrates. Therefore, there is still a need to explore other technical solutions that can meet the demand.

### SUMMARY OF THE INVENTION

One objective of the present invention is to provide a water-based binder composition comprising:
A) a waterborne poly(meth)acrylate emulsion comprising:
   (A1) An acidic polymer stabilizer with a weight average molecular weight (Mw) in the range of 4,000 to 18,000, an acid value (AV), before neutralizing, in the range of 60 to 200 and an oxygen content of at least 15 wt %, and
   (A2) A base polymer with an oxygen content of at least 12 wt %;
   Wherein the acidic polymer may be presented in the range of 20 wt % to 70 wt %, based on the total dry weight of the waterborne poly(meth)acrylate emulsion, and the theoretical acid value (TAV) of the waterborne poly(meth)acrylate emulsion is in the range of 15 to 60.
B) a polyurethane made of components comprising:
   (B1) at least one diisocyanate,
   (B2) at least one diol having number average molecular weight of from 500 to 5000 g/mol, preferably from about 1000 to 3000 g/mol, and
   (B3) at least one mono-hydroxy functional compound having a number average molecular weight of from 500 to 5000 g/mol.

Preferably, the water-based binder composition comprising:
A) a waterborne poly(meth)acrylate emulsion comprising:
   (A1) An acidic polymer stabilizer with a weight average molecular weight (Mw) in the range of 4,000 to 18,000, an acid value (AV), before neutralizing, in the range of 60 to 200 and an oxygen content of at least 15 wt %, and
   (A2) A base polymer with an oxygen content of at least 12 wt %;
   Wherein the acidic polymer may be presented in the range of 20 wt % to 70 wt %, based on the total dry weight of the waterborne poly(meth)acrylate emulsion, and the theoretical acid value (TAV) of the waterborne poly(meth)acrylate emulsion is in the range of 15 to 60.
B) a polyurethane made of components comprising:
   (B1) at least one diisocyanate,
   (B2) at least one diol having number average molecular weight of from 500 to 5000 g/mol, preferably from about 1000 to 3000 g/mol,
   (B3) at least one mono-hydroxy functional compound having a number average molecular weight of from 500 to 5000 g/mol,
   (B4) at least one of the diols is polytetrahydrofuran having a number average molecular weight of from 500 to 5000 g/mol, preferably from about 1000 to 3000 g/mol,
   (B5) at least one diamino acid compound, and
   (B6) at least one polyamine compound having at least two amino groups and no acid group.

Another objective of the present invention is to water-based printing ink comprising the abovementioned water-based binder.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The designation (meth)acrylate and similar designations are used herein as an abbreviated notation for “acrylate and/or methacrylate”.

All percentages and ratios denote weight percentages and weight ratios unless otherwise specified.

The term weight average molecular weight (Mw) means a molecular weight measured by Gel Permeation Chromatography (GPC) against polystyrene standard in tetrahydrofuran with the unit of g/mol.

The term oxygen content of a polymer refers to the weight ratio of oxygen atoms in the respective polymer.

The term acid value (AV) refers to the acid number reported in mg KOH (base) per g of the resin, determined by titration of the bulk resin dissolved in tetrahydrofuran (THF) with a 0.1M KOH aqueous solution. And the term theoretical acid value (TAV) refers the theoretical acid number as calculated with the following equation:

TAV=AV_{acid polymer}*(weight percentage of the acid polymer over the total weight of the emulsion)+AV_{basepolymer}*(weight percentage of the base polymer over the total weight of the emulsion).

One objective of the present invention is to provide a water-based binder composition comprising:
A) a waterborne poly(meth)acrylate emulsion comprising:
   (A1) an acidic polymer stabilizer with a weight average molecular weight (Mw) in the range of 4,000 to 18,000, an acid value (AV), before neutralizing, in the range of 60 to 200 and an oxygen content of at least 15 wt %, and
   (A2) a base polymer with an oxygen content of at least 12 wt %;
   Wherein the acidic polymer may be presented in the range of 20 wt % to 70 wt %, based on the total dry weight of the waterborne poly(meth)acrylate emulsion, and the theoretical acid value (TAV) of the waterborne poly(meth)acrylate emulsion is in the range of 15 to 60.
B) a polyurethane made of components comprising:
   (1) at least one diisocyanate,
   (B2) at least one diol having number average molecular weight of from 500 to 5000 g/mol, preferably from about 1000 to 3000 g/mol, and
   (B3) at least one mono-hydroxy functional compound having a number average molecular weight of from 500 to 5000 g/mol.

In one aspect, the acidic polymer stabilizer (A1) includes a polymerization product of a mixture comprising at least one hydrophobic monoethylenically unsaturated monomer and at least one hydrophilic monoethylenically unsaturated monomer, wherein the polymer stabilizer is water soluble upon neutralization; the polymer stabilizer shall have a Mw in the range of 4,000 to 18,000; an acid value from 60 to about 200 and an oxygen content of at least 15 wt %.

The at least one hydrophobic monoethylenically unsaturated monomer may be selected from the group consisting of (meth)acrylate monomers, (meth)acrylonitrile monomers, styrene monomers, vinyl alkanoate monomers and monoethylenically unsaturated di- and tricarboxylic ester monomers.

Particularly, the (meth)acrylate monomers may be C₁-C₁₉-alkyl (meth)acrylates, for example, but not limited to, methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl(meth)acrylate, n-dodecyl (meth)acrylate (i.e. lauryl (meth)acrylate), tetradecyl(meth)acrylate, oleyl(meth)acrylate, palmityl(meth)acrylate, stearyl (meth)acrylate, isobornyl (meth)acrylate, benzyl (meth)acrylate, phenyl (meth)acrylate and a mixture thereof.

Particularly, the styrene monomers may be unsubstituted styrene or C1-C6-alkyl substituted styrenes, for example, but not limited to, styrene, α-methylstyrene, ortho-, meta- and para-methylstyrene, ortho-, meta- and para-ethylstyrene, o,p-dimethylstyrene, o,p-diethylstyrene, ispropylstyrene, o-methyl-p-isopropylstyrene or any mixture thereof.

Particularly, the vinyl alkanoate monomers may be vinyl esters of C₂-C₁₁-alkanoic acids, for example, but not limited to, vinyl acetate, vinyl propionate, vinyl butanoate, vinyl valerate, vinyl hexanoate, vinyl versatate or a mixture thereof.

In addition, the monoethylenically unsaturated di- and tricarboxylic ester monomers may be full esters of monoethylenically unsaturated di- and tricarboxylic acids, for example, but not limited to, diethyl maleate, dimethyl fumarate, ethyl methyl itaconate, or any mixture thereof.

In a preferred embodiment according to the present invention, one or more C₁-C₁₂-alkyl (meth)acrylates, such as methyl (meth)acrylate, ethyl (meth)acrylate, n-butyl (meth)acrylate and 2-ethylhexyl (meth)acrylate, styrene or a mixture thereof is chosen as the at least one hydrophobic monoethylenically unsaturated monomer.

The hydrophobic monomer may account for, based on the total weight of the acidic polymer stabilizer (A1), at least 85 wt %, preferably at least 90 wt %, more preferably at least 95% by weight.

The at least one hydrophilic monoethylenically unsaturated monomer may be monoethylenically unsaturated monomers containing at least one functional group selected from the group consisting of carboxyl, carboxylic anhydride, sulfonic acid, phosphoric acid, hydroxyl and amide.

Particularly, the hydrophilic monoethylenically unsaturated monomer includes, but is not limited to, monoethylenically unsaturated carboxylic acids, such as (meth)acrylic acid, itaconic acid, fumaric acid, citraconic acid, sorbic acid, cinnamic acid, glutaconic acid and maleic acid; monoethylenically unsaturated carboxylic anhydride, such as itaconic acid anhydride, fumaric acid anhydride, citraconic acid anhydride, sorbic acid anhydride, cinnamic acid anhydride, glutaconic acid anhydride and maleic acid anhydride; monoethylenically unsaturated amides, especially N-alkylolamides, such as (meth)acrylamide, N-methylol (meth)acrylamide, 2-hydroxyethyl (meth)acrylamide; and hydroxyalkyl esters of monoethylenically unsaturated carboxylic acids, such as hydroxyethyl (meth)acrylate and hydroxypropyl (meth)acrylate.

In a preferred embodiment according to the present invention, acrylic acid, methacrylic acid, itaconic acid, acrylamide, methacrylamide or a mixture thereof is preferred as the at least one hydrophilic monoethylenically unsaturated monomer.

The hydrophilic monomer may account for, based on the total weight of the acidic polymer stabilizer (A1), at least 0.2 wt % and no more than 15 wt %, preferably at least 0.5 wt % and no more than 10 wt %, and more preferably at least 1 wt % and no more than 5 wt %.

In one embodiment, the monomer mixture for the acidic polymer stabilizer (A1) includes at least two (meth)acrylates selected from ethyl acrylate, ethyl methacrylate, methyl methacrylate, vinyl acetate, methyl acrylate, 2-ethylhexyl (meth)acrylate, 2-hydroxyethyl methacrylate, 2-hydroxyethyl acrylate, glycidyl acrylate, glycidyl methacrylate, propyl acrylate, propyl methacrylate, (polyethylene glycol) methyl ether acrylate, or (polyethylene glycol) methyl ether methacrylate; and at least one a (meth)acrylic acid selected from acrylic acid, methacrylic acid, itaconic acid, maleic acid, fumaric acid, and crotonic acid. In a preferred embodiment, the monomer mixture for the acidic polymer stabilizer (A1) includes methyl methacrylate, styrene, 2-ethylhexyl (meth)acrylate and acrylic acid.

In addition, the acidic polymer stabilizer (A1) may be synthesized with the presence of at least one chain transfer agent. Chain transfer agents are frequently used to regulate the molecular weight of polymers. Chain transfer agents may include, but not limited to, compounds containing a thiol group, for example mercaptans, such as without limitation, ethyl mercaptan, n-propyl mercaptan, n-butyl mercaptan, isobutyl mercaptan, t-butyl mercaptan, n-amyl mercaptan, isoamyl mercaptan, t-amyl mercaptan, n-hexyl mercaptan, cyclohexyl mercaptan, n-octyl mercaptan, n-decyl mercaptan, n-dodecyl mercaptan, mercapto carboxylic acids and their esters, such as without limitation, 2-ethylhexyl thioglycolate, methyl mercaptopropionate and 3-mercaptopropionic acid, alcohols, such as isopropanol, isobutanol, lauryl alcohol and t-octyl alcohol, halogenated compounds such as carbon tetrachloride, tetrachloroethylene, tricholoro-bromoethane, and any combination thereof.

The chain transfer agent may be added in an amount of, based on the total weight of the acidic polymer stabilizer (A1), no more than 1 wt %, preferably no more than 0.5 wt %, and more preferably no more than 0.2 wt %.

The acidic polymer stabilizer (A1) may have a Mw in the range of 4,000 to 18,000, preferably in the range of 5,000 to 13,000, and most preferably in the range of 5,000 to 12,000.

The acid value (AV) of the acidic polymer stabilizer (A1) may be in the range of 60 to 200, preferably in the range of 65 to 180, more preferably in the range of 70 to 160, and mostly preferably in the range of 75 to 150.

The acidic polymer stabilizer (A1) may have an oxygen of at least 15 wt %, preferably at least 18 wt %, more preferably at least 20 wt %, and most preferably at least 22 wt %.

The base polymer according to the present invention may be synthesized with a mixture comprising at least one hydrophobic monoethylenically unsaturated monomer and at least one hydrophilic monoethylenically unsaturated monomer. The hydrophobic monoethylenically unsaturated monomer and the hydrophilic monoethylenically unsaturated monomer may or may not be the same as that for the acidic polymer stabilizer (A1). There is no specific limitation and/or preference over the monomer that can be used. For example, methyl (meth)acrylate, ethyl (meth)acrylate, n-butyl (meth)acrylate and 2-ethylhexyl (meth)acrylate, styrene or a mixture thereof is chosen as the at least one hydrophobic monoethylenically unsaturated monomer may be chosen as the at least one hydrophobic monoethylenically unsaturated monomer while acrylic acid, methacrylic acid, itaconic acid, acrylamide, methacrylamide or a mixture thereof is preferred as the at least one hydrophilic monoethylenically unsaturated monomer.

The hydrophobic monomer may account for, based on the total weight of the base polymer, at least 85 wt %, preferably at least 90 wt %, more preferably at least 95% by weight. And, the hydrophilic monomer may account for, based on the total weight of the acidic polymer stabilizer (A1), at least 0.2 wt % and no more than 15 wt %, preferably at least 0.5 wt % and no more than 10 wt %, and more preferably at least 1 wt % and no more than 5 wt %.

The monomers for the base polymer of the present invention may further comprise one or more crosslinking monomers. The crosslinking monomers can be chosen from di- or polyisocyanates, polyaziridines, polycarbodiimide, polyoxazolines, glyoxals, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol(meth)acrylamide, (isobutoxymethyl)acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl)trimethoxysilane and (3-methacryloxypropyl)trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof.

The crosslinker can be added in an amount of no more than 10% by weight, preferably no more than 8% by weight, more preferably no more than 5% by weight, based on the total weight of the base polymer.

Without bonding to any specific theory, lower oxygen content of the base polymer will deteriorate the alcohol tolerance performance of the waterborne poly(meth)acrylate emulsion. Therefore, the base polymer shall have an oxygen content of at least 12 wt %, preferably at least 15 wt %, and more preferably at least 20 wt %.

The base polymer may have a weight average molecular weight (Mw) in the range of 5,000 to 3,000,000, preferably from 10,000 to 100,000, and more preferably from 15,000 to 50,000.

There is no specific limitation on the glass transition temperature (Tg) of the base polymer. For example, Tg of the base polymer may be in the range of −60 to 120° C., or in the range of −40 to 60° C., or in the range of −20 to 0° C.

Within the context of the present application, the term Fox Tg refers to a glass transition temperature (Tg) as calculated according to the following Fox equation as disclosed in T.G. Fox, Bulletin of the American Physical Society, Volume 1, Issue No. 3, page 123 (1956):

1/Tg=W₁/Tg₁+W₂/Tg₂+ . . . +Wₙ/Tgₙ
wherein
W₁, W₂, . . . Wₙ, are the mass fractions of the monomers 1, 2, . . . n, respectively, and
Tg₁, Tg₂, . . . Tgₙ, are the glass transition temperatures of homopolymers of the monomers 1, 2, . . . n in degrees Kelvin, respectively.

The Tg values for homopolymers of the majority of monomers are known and are listed in, for example, Ullmann's Ecyclopedia of Industrial Chemistry, Vol. 5, Vol. A21, page 169, VCH Weinheim, 1992. Other sources of glass transition temperatures of homopolymers include, for example, J. Brandrup, E. H. Immergut, Polymer Handbook, 1st Edition, J. Wiley, New York 1966, 2nd Edition, J. Wiley, New York 1975, and 3rd Edition, J. Wiley, New York 1989.

According to the present invention, the acidic polymer may be presented in the range of 15 wt % to 70 wt %, preferably in the range of 20 wt % to 65 wt %, more preferably in the range of 25 wt % to 60 wt %, based on the total dry weight of the waterborne poly(meth)acrylate emulsion.

According to the present invention, the theoretical acid value (TAV) of the waterborne poly(meth)acrylate emulsion is in the range of 15 to 60, preferably in the range of 18 to 55, more preferably in the range of 20 to 50.

In one embodiment of the present invention, the acidic polymer may be presented in the range of 15 wt % to 70 wt %, based on the total dry weight of the waterborne poly(meth)acrylate emulsion, and the theoretical acid value (TAV) of the waterborne poly(meth)acrylate emulsion is in the range of 15 to 60.

In one embodiment of the present invention, the acidic polymer may be presented in the range of 20 wt % to 65 wt %, based on the total dry weight of the waterborne poly(meth)acrylate emulsion, and the theoretical acid value (TAV) of the waterborne poly(meth)acrylate emulsion is in the range of 18 to 55.

In one embodiment of the present invention, the acidic polymer may be presented in the range of 25 wt % to 60 wt %, based on the total dry weight of the waterborne poly(meth)acrylate emulsion, and the theoretical acid value (TAV) of the waterborne poly(meth)acrylate emulsion is in the range of 20 to 50.

In one aspect, the polyurethane (B) is made of components comprising (1) at least one diisocyanate, (B2) at least one diol having number average molecular weight of from 500 to 5000 g/mol, preferably from about 1000 to 3000 g/mol, and (B3) at least one mono-hydroxy functional compound having a number average molecular weight of from 500 to 5000 g/mol.

The at least one diisocyanate (1) is selected from the diisocyanates X(NCO)2, where X is an aliphatic hydrocarbon radical of 4 to 12 carbons, a cycloaliphatic hydrocarbon radical of 6 to 15 carbons or an aromatic hydrocarbon radical of 6 to 15 carbons or an araliphatic hydrocarbon radical of 7 to 15 carbons. Examples of such diisocyanates are tetramethylene diisocyanate, hexamethylene diisocyanate (HDI), dodecamethylene diiso-cyanate, 1,4-diisocyanatocyclohexane, 1-isocyanato-3,5,5-trimethyl-5-isocyanatomethylcyclo-hexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethyl-xylylene diisocyanate (TMXDI), the isomers of bis(4-isocyanatocyclohexyl)methane (HMDI, such as the trans/trans, the cis/cis and the cis/trans isomer), and mixtures of these compounds. Particularly important mixtures of these isocyanates are the mixtures of the respective structural isomers of diisocyanatotoluene and diisocyanato diphenylmethane, especially the mixture comprising 80 mol % 2,4-diisocyanatotoluene and 20 mol % 2,6-diisocyanatotoluene. In addition, the mixtures of aromatic isocyanates, such as 2,4-diisocyanatotoluene and/or 2,6-diisocyanatotoluene, with aliphatic or cycloaliphatic isocyanates, such as hexamethylene diisocyanate or IPDI, are particularly advantageous, the preferred proportion of aliphatic to aromatic isocyanates being from 4:1 to 1:4. In addition to the above mentioned isocyanates, other isocyanates which can be employed as compounds to synthesize the polyurethanes are those which carry not only the free isocyanate groups but also further, blocked isocyanate groups, examples being uretdione groups. Especially preferred are polyisocyanates (1) selected from the group consisting of 1-isocyanato-3,5,5-trimethyl-5-isocyanatomethylcyclohexane (IPDI), tetramethylxylylene diisocyanate (TMXDI), hexamethylene diisocyanate (HDI), bis(4-isocyanatocyclohexyl)methane (HMDI) or mixtures thereof.

The at least one diisocyanate (1) may be presented in an amount of 5 wt % to 30 wt %, preferably in an amount of 10 wt % to 25 wt %, based on the total weight of the polyurethane (B).

The at least one diol (B2) is preferably selected from the group consisting of polyesterdiols and polyetherdiols and mixtures thereof. When used in combination, the weight ratio of polyesterdiols and polyetherdiols is preferably froml 1:3 to 3:1 more preferably from 1:2 to 2:1.

The polyesterdiols are, in particular, polyesterpolyols which are known, for example, from Ullmann's Encyklopadie der technischen Chemie, 4th Edition, Vol. 19, pp. 62 to 65. It is preferred to employ polyesterpolyols that are obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyesterpolyols. The polycarboxylic acids can be aliphatic, cycloaliphatic, araliphatic, aromatic or heterocyclic and can be unsubstituted or substituted (by halogen atoms, for example), and/or saturated or unsaturated. Examples are suberic, azelaic, phthalic and isophthalic acid, phthalic, tetrahydrophthalic, hexahydrophthalic, tetrachlorophthalic, endomethylenetetrahydrophthalic, glutaric and maleic anhydride, maleic acid, fumaric acid and dimeric fatty acids. Preference is given to dicarboxylic acids of the formula HOOC—(CH2)y-COOH, where y is a number from 1 to 20, preferably an even number from 2 to 20, examples being succinic, adipic, sebacic and dodecanedicarboxylic acids.

Examples of suitable polyhydric alcohols for making the polyesterdiols are ethylene glycol, 1,2-propanediol, 1,3-propanediol, 1,3-butanediol, 1,4-butanediol, 1,4-butenediol, 1,4-butynediol, 1,5-pentanediol, neopentyl glycol, bis(hydroxymethyl)cyclohexanes such as 1,4-bis(hydroxy-methyl)cyclohexane, 2-methyl-1,3-propanediol, methylpentanediols, and also diethylene glycol, triethylene glycol, tetraethylene glycol, polyethylene glycol, dipropylene glycol, polypropylene glycol, dibutylene glycol and polybutylene glycols. Preference is given to alcohols of the formula HO—(CH2)x-OH, where x is a number from 1 to 20, preferably an even number from 2 to 20. Examples of such alcohols are ethylene glycol, 1,4-butanediol, 1,6-hexanediol, 1,8-octanediol and 1,12-dodecanediol. Preference extends to neopentyl glycol.

Also suitable are polycarbonatediols, as can be obtained, for example, by reaction of phosgene with an excess of the low molecular mass alcohols cited above as structural components for the polyesterpolyols. Lactone-based polyesterdiols are also suitable, these being homopolymers or copolymers of lactones, preferably hydroxy-terminal adducts of lactones with suitable difunctional starter molecules. Suitable lactones are preferably those derived from compounds of the formula HO—(CH2)z-COOH, where z is from 1 to 20 and one hydrogen of a methylene unit can also be substituted by a C1-C4-alkyl. Examples are [epsilon]-caprolactone, [beta]-propiolactone, [gamma]-butyrolactone and/or methyl-[epsilon]-caprolactone, and mixtures thereof. Examples of suitable starter components are the low molecular mass dihydric alcohols cited above as structural components for the polyesterpolyols. The corresponding polymers of [epsilon]-caprolactone are particularly preferred. Lower polyesterdiols or polyetherdiols can also be employed as starters for preparing the lactone polymers. Instead of the polymers of lactones it is also possible to employ the corresponding, chemically equivalent polycondensates of the hydroxycarboxylic acids which correspond to the lactones.

Suitable polyetherdiols can in particular be obtained via polymerization of ethylene oxide, propylene oxide, butylene oxide, tetrahydrofuran, styrene oxide, or epichlorohydrin with itself, e.g. in the presence of BF3, or via adduct-formation of said compounds optionally in a mixture or in succession, with starter components having reactive hydrogen atoms, for example alcohols or amines, e.g. water, ethylene glycol, propane-1,2-diol, propane-1,3-diol, 2,2-bis(4-hydroxy-phenyl)propane, or aniline. Examples of polyetherdiols are polypropylene oxide, polytetra-hydrofuran with a molar mass of 240 to 5000 g/mol, and especially 500 to 4500 g/mol.

The at least one diol (B2) is preferably used in amounts of 10 wt % to 80 wt %, more preferred from 20 wt % to 70 wt %, based on the total weight of the polyurethane (B).

The at least one one mono-hydroxy functional compound is a monohydroxy-poly(alkylene oxide) compound. Suitable compounds (B3) are alkanol started polyalkylene glycols. These compounds have an alkyl group at one terminal end and a hydroxy group at the other terminal end of the polymer. The alkanol has preferably 2 to 8 or 2 to 5 carbon atoms such as ethanol, propanol or butanol, preferably n-butanol. The alkylene group is for example ethylene, propylene or a mixture thereof, preferably ethylene. The general formula can be HO-(A-0)n-R with A being an alkylene group as mentioned above, R being an alkyl group as mentioned above and n being a number from 20 to 65. The OH-number of the monohydroxy-poly(alkylene oxide) compound (B3) is preferably from 10 to 250, or from 10 to 100 or from 15 to 56 mg KOH/g.

The compound (B3) is preferably used in amounts of 1 wt % to 20 wt %, more preferably in amounts of from 4 wt % to 15 wt % or from 7 wt % to 15 wt %, based on the total weight of the polyurethane (B). The components (B2) and (B3) together constitute preferably at least 75% of the weight of the polyurethane (B).

In a preferred embodiment, the compounds used to make the polyurethane (B) further comprise at least one polytetrahydrofuran diols (B4) having a number average molecular weight of from 500 to 5000 g/mol, preferably from about 1000 to 3000 g/mol. The polytetrahydrofuran diols (B4) is obtainable in particular by addition polymerization of tetrahydrofuran with itself, in the presence, for example, of BF3, or by addition reaction onto starter components containing reactive hydrogens, such as alcohols or amines, examples being water, ethylene glycol, 1,2-propanediol, 1,3-propanediol, 1,2-bis(4-hydroxydiphenyl)propane or aniline. Particular preference is given to polytetrahydrofuran having a number average molecular weight of from 500 to 5000 and, in particular, from 500 to 4500 or from 1000 to 3000 g/mol.

When the polytetrahydrofuran diols (B4) is applied, the total amount of diols remains in the range of 10 wt % to 80 wt %, more preferred from 20 wt % to 70 wt %, based on the total weight of the polyurethane (B).

In another preferred embodiment, the compounds used to make the polyurethane (B) further comprise at least one diamino acid compound (B5). Suitable diamino acid compounds (B5) can be selected from the group consisting of diamino carboxylic acid compounds and diamino sulfonic acid compounds. Such compounds conform for example to the formula H2N—R1—NH—R2—X where R1 and R2 independently of one another are a C1-C6-alkanediyl, preferably ethylene, and X is COOH or S03H. Particularly preferred diamino acid compounds (B5) are N-(2-aminoethyl)-2-aminoethane carboxylic acid and N-(2-aminoethyl)-2-aminoethane sulfonic acid and the corresponding alkali metal salts, Na being the particularly preferred counterion.

The at least one diamino acid compound (B5) is preferably used in amounts of 1 wt % to 10 wt %, more preferred from 1 wt % to 5 wt %, based on the total weight of the polyurethane (B).

In another preferred embodiment, the compounds used to make the polyurethane (B) further comprise at least one polyamine compound (B6). The polyamine compounds (B6) can serve generally for crosslinking or chain extension and typically have 2 or more primary and/or secondary amino groups. Polyamines having 2 or more primary and/or secondary amino groups are employed in particular when chain extension and/or crosslinking is to take place in the presence of water, since amines generally react more quickly with isocyanates than do alcohols or water. This is in many cases necessary when the desire is for aqueous dispersions of crosslinked polyurethanes, or polyurethanes of high molar weight. In such cases a procedure is followed in which prepolymers with isocyanate groups are prepared, are rapidly dispersed in water and then are subjected to chain extension or crosslinking by adding compounds having two or more isocyanate-reactive amino groups. Amines suitable for this purpose are, in general, polyfunctional amines with a molar weight in the range from 32 to 500 g/mol, preferably from 60 to 300 g/mol, having at least two amino groups selected from the group consisting of primary and secondary amino groups. Examples are diamines such as diaminoethane, diaminopropanes, diaminobutanes, diaminohexanes, piperazine, 2,5-dimethylpiperazine, amino-3-aminomethyl-3,5,5-trimethyl-cyclohexane (isophoronediamine, IPDA), 4,4′-diaminodicyclo-hexylmethane, 1,4-diaminocyclohexane, aminoethylethanolamine, hydrazine, hydrazine hydrate or triamines such as diethylenetriamine or 1,8-diamino-4-aminomethyloctane. It is preferred to use mixtures of diamines and triamines, especially mixtures of isophoronediamine (IPDA) and diethylenetriamine (DETA). The polyurethanes contain preferably from 1 to 30 mol %, especially from 4 to 25 mol %, based on the total amount of polyurethane components, of a polyamine having at least 2 isocyanate-reactive amino groups, as monomers (B5). Preferably, the polyamine compound is selected from the group consisting of isophoronediamine, diethylenetriamine and mixtures thereof.

The at least one polyamine compound (B6) is preferably used in amounts of 0.1 wt % to 10 wt %, more preferred from 0.1 wt % to 2 wt %, based on the total weight of the polyurethane (B).

The hardness and the modulus of elasticity of the polyurethanes can be raised by employing low molecular mass polyols (B7) (preferably diols) having a molecular weight of less than 500 g/mol, e.g. from about 60 to 490 g/mol, preferably from 62 to 200 g/mol. The amount of low molecular weight polyols (B7) is preferably 0 to 10% by weight, more preferably from 1 to 8% by weight. Compounds employed as low molecular mass polyols (B7) are in particular the structural components of the short-chain alkanediols cited for the preparation of polyesterdiols, preference being given to the diols having 2 to 12 carbons, to the unbranched diols having 2 to 12 carbons and an even number of carbons, and to 1,5-pentanediol, 1,4-butanediol and neopentyl glycol.

In one aspect of the invention, the polyurethane (B) is made exclusively from components (1) to (B3) or exclusively from components (1) to (B6) or exclusively from components (1) to (B7) as mentioned above or.

Another objective of the present invention is to water-based printing ink comprising the abovementioned waterborne poly(meth)acrylate and polyurethane as binders. The waterborne poly(meth)acrylate (solid) and the polyurethane (solid) are present in a weight ratio from 1:9 to 9:1, preferably from 1:5 to 5:1, or from 1:4 to 4:1, more preferred from 1:3 to 3:1. The binders can preferably be exclusively a mixture of the polyurethane and the poly(meth)acrylate dispersion binder as defined herein without any other binder. But, if any different binder resins are used, they preferably do not exceed about 50 wt. % or 20 wt. % of the total amount of binder. The inks are preferably free of volatile tertiary amines, residual isocyanate and tin. The (lamination) printing ink of this invention may be used in either flexographic or gravure printing by simply making minor adjustments to the formulation concentrations. Thus, the component concentrations may be adjusted for use in flexography or gravure printing. For example, a gravure ink or a flexographic ink preferably comprises about 8 to 60 wt. % of the binder, about 3 to 30 wt. % of the pigment colorant and about 15 to 60 wt. % solvent or water. The ink preferably has a viscosity between about 15 seconds to 30 seconds, as measured in a #2 efflux cup. Efflux cup measurement is the conventional method for measuring ink viscosities and involves timing the flow of a calibrated quantity of ink through a calibrated orifice. The lower viscosity inks typically are used in gravure printing and the higher viscosity inks typically are used in flexographic printing. Thus, when the ink has a viscosity of about 28 seconds as measured in a #2 efflux cup, it is suitable for flexographic printing, and when the ink has a viscosity of about 18 seconds as measured in a #2 efflux cup, it is suitable for gravure printing.

The binders are film forming upon removal of the water or of the water/solvent mixture. The inks include a colorant in addition to the binder and solvent. The colorant is one or more pigment or possibly a combination of pigment and one or more dyes. The colorant may be organic or inorganic. The most common pigments include azo dyes (for example, Solvent Yellow 14, Dispersed Yellow 23, and Metanil Yellow), anthraquinone dyes (for example, Solvent Red 1 1 1, Dispersed Violet 1, Solvent Blue 56, and Solvent Orange 3), xanthene dyes (Solvent Green 4, Acid Red 52, Basic Red 1, and Solvent Orange 63), azine dyes (for example, Jet Black), and the like. Major usable organic pigments include diarylide yellow AAOT (for example, Pigment Yellow 14 CI #21095), diarylide yellow AAOA (for example, Pigment Yellow 12 CI #21090), Phthalocyanine Blue (for example, Pigment Blue 15), lithol red (for example, Pigment Red 52:1 C 5860:1), toluidine red (for example, Pigment Red 22 CI #12315), dioxazine violet (for example, Pigment Violet 23 CI #51319), phthalocyanine green (for example, Pigment Green 7 CI #74260), phthalocyanine blue (for example, Pigment Blue 15 CI #74160), naphthoic acid red (for example, Pigment Red 48:2 CI #15865:2). Inorganic pigments include titanium dioxide (for example, Pigment White 6 CI #77891), carbon black (for example, Pigment Black 7 CI #77266), iron oxides (for example, red, yellow, and brown), ferric oxide black (for example, Pigment Black 1 1 CI #77499), chromium oxide (for example, green), ferric ammonium ferrocyanide (for example, blue), and the like. The colorant is not limited to the foregoing. Thus, the colorant may be any conventional organic or inorganic pigment such as Zinc Sulfide, Pigment White 6, Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 1 14, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57, Pigment Red 1 12, Pigment Red 122, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 19, Pigment Violet 23, Pigment Black 7 and the like.

The printing inks may also contain the usual ink additives to adjust flow, surface tension, and gloss of a printed ink. Such additives typically are polymeric dispersants, surface active agents, waxes, or a combination thereof. These additives may function as leveling agents, wetting agents, fillers, dispersants, defrothers or deaerators, or additional adjuvants may be added to provide a specific function. The lamination printing inks may contain a polymeric dispersant when the colorant is a pigment to disperse the pigment during mixing and grinding operations in the solvent. All components of the ink may be blended together and ground to reduce the pigment particles to the desired size distribution, typically 10 microns or less, or alternatively the pigment and the polymeric dispersant can be premixed and ground in the solvent (the medium) to form a “base” which is subsequently blended with the remaining components of the ink composition. The ink components may be mixed in a high speed mixer until a slurry consistency is reached and then passed through a media mill until the pigment is reduced to 10 microns or smaller. The wide versatility of the inks of this invention allows them to be prepared without a polymeric dispersant, but preferably they are made with a polymeric dispersant for grinding in, for example, polyvinyl butyral or blending with, for instance, a nitrocellulose base or an acrylic resin solution. Thus, the ink of this invention may contain 0 to about 12 parts by weight of the polymeric dispersant. Other useful colorants, solvents and adjuvants can be identified by consulting The Printing Ink Manual.

The printing ink preferably comprises 8 to 60% by weight, preferably 15 to 50% by weight of the at water-based binder composition, 3 to 30% by weight, preferably 6 to 30% by weight of pigments, 15 to 60% by weight, preferably 30 to 60% by weight of water and 0,1 to 5% by weight of additives such as surfactants, antifoam agents, and waxes.

The present technology, thus generally described, will be understood more readily by reference to the following example, which is provided by way of illustration and is not intended to limit the present technology.

### Examples

### Preparation of the Acidic Polymer Stabilizer (“APS”)

Monomers (as indicated in Table 1) were first weighed out in appropriate amounts and mixed with a solvent to form a clear solution. Di-tert-amyl peroxide (DTAP, 0.5 wt % based on the total amount of monomers) was added to the mixture and mixed until the entire solution was clear. The solution was then fed to a continuous stirred tank reactor operating a 160° C. and product continuously withdrawn so as to maintain an appropriate residence time (about 15 min) in the reactor. The product from the reactor was continuously charged to an evaporated operating at elevated temperature and under vacuum to remove unreacted monomer and solvent from the resin product. The resin product was then analyzed for molecular weight and acid value. The composition of the polymer was estimated by either assuming it was identical to the composition of the monomers in the feed, or by mass balance on the individual monomers fed to the reactor. Oxygen content was calculated from the computed polymer composition.

TABLE 1
Summary of Polymerization Results for
Making the Acidic Polymer Stabilizer

| | AA | MAA | ST | MMA | 2-EHA | BA | Mw | AV | O₂ |
|---|---|---|---|---|---|---|---|---|---|
| APS1 | 9.5 | | 25 | 55 | 10.5 | | 14.7 | 74 | 23.6 |
| APS2 | | 19 | | 64 | | 17 | 8.0 | 125 | 31.4 |
| APS3 | | 10 | | 30 | 30 | 30 | 9.0 | 63 | 25.6 |
| APS4 | 32 | | 50 | 18 | | | 9.4 | 200 | 16.9 |

AA = acrylic acid (in wt %, based on the total weight of monomers);
MAA = methyl acrylic acid (in wt %, based on the total weight of monomers);
ST = styrene (in wt %, based on the total weight of monomers);
MMA = methyl methacrylate (in wt %, based on the total weight of monomers);
2-EHA = 2-ethyl hexyl acrylate (in wt %, based on the total weight of monomers);
BA = butyl acrylate (in wt %, based on the total weight of monomers)
AA (in wt %) + MAA (in wt %) + ST (in wt %) + MMA (in wt %) + 2-EHA (in wt %) + BA (in wt %) = 100%
Mw is the weight average molecular weight (in KDa)
AV = Acid Value
O₂ = Oxygen content

### Typical Procedure to Make an Acidic Polymer Stabilizer Solution (“APS Solution”)

De-ionized water (667.5 g) and 300 g of a dry acidic polymer stabilizer from Table 1 were charged into a 2 L reactor. An ammonia solution (28% solution in water, 32.5 g) was added to the reactor with stirring at room temperature in 10 minute. The reactor was heated to a temperature of 60° C., and stirred for 2 hours at 60° C. The solution was then cooled to room temperature and filtered to produce. The final acidic polymer stabilizer solution (APS solution) has a pH of about 8.3 and a solid content of about 30 wt %.

### Typical Procedure to Prepare a Polyacrylate Emulsion

De-ionized water (339.7 g), APS solution (291.4 g) as listed in Table 1, Disponil LDBS (7.78 g) were charged into a 2 L reactor and heated to 85° C. with stirring. Ammonium persulfate (1.73 g) was added with water (6.94 g). A monomer mixture as listed in Table 2 (with a total weight of 349.45 g) was fed slowly into the reactor over 60 minutes. Afterwards, it was cooled to 40° C., A biocide (3 g) was added at the end. The final emulsion has a pH of about 8.2 and a solid content of about 44 wt %.

TABLE 2
Summary of the Synthesis of the waterborne
poly(meth) acrylate emulsion

| | APS solution | Monomers | | | | |
|---|---|---|---|---|---|---|
| | Type | St* | MMA* | BA* | DAAM* | EHA |
| PA 1 | APS1 Solution | | 24.4 | 73.3 | 2.3 | |
| PA 2 | APS2 Solution | | 24.4 | 73.3 | 2.3 | |
| PA 3 | APS3 Solution | 15 | 40 | 15 | | 30 |
| PA 4 | APS4 Solution | | 40 | 10 | | 50 |

*Weight percentage based on the total weight of monomers

Typical procedure to prepare a polyurethane dispersion

TABLE 3
Polyurethane dispersion (PUD) components

| | | | | Weight % | |
|---|---|---|---|---|---|
| | | Equiv. | Amount | (solid | Equivalent (OH, |
| Equiv. | Component | MW | (g) | PUD) | NCO, NH) |
| Pre- | polyester based on adipic | 1020 | 205.2 | 32.1 | 0.201 |
| charge | acid, neopentylglycol, 1,6- | | | | |
| | hexanediol; OH number = | | | | |
| | 56 mg KOH/g | | | | |
| | pTHF2000 | 1000 | 201.2 | 31.5 | 0.201 |
| | n-butanol started | 2158 | 46.55 | 7.3 | 0.0216 |
| | polyethylene glycol | | | | |
| | (monohydric alcohol); OH | | | | |
| | number = 26 mg KOH/g | | | | |
| | Bismuth neodecanoate | | 0.3 | 0.05 | / |
| | cat. (CAS = 34364-26-6) | | | | |
| Feed 1 | Isophorone diisocyanates | 111.1 | 66.6 | 10.4 | 0.599 |
| | (IPDI) | | | | |
| | H₁₂ MDI (Desmodur ® W) | 132.1 | 79.13 | 12.4 | 0.599 |
| Feed 2 | Acetone | | 109 | | |
| Feed 3 | 1,4-butanediol | 45.05 | 21.34 | 3.34 | 0.474 |
| Feed 4 | Acetone | | 468.1 | | |
| Feed 5 | 40% solution in H₂O of | 208.6 | 30 | 1.88 | 0.144 |
| | sodium N-(2-aminoethyl)- | | | | |
| | beta-alaninate | | | | |
| Feed 6 | Water | | 730.1 | | |
| Feed 7 | isophoronediamine | 84.37 | 2.02 | 0.32 | 0.0239 |
| | (IPDA) | | | | |
| | Diethylenetriamine | 34.53 | 4.14 | 0.65 | 0.12 |
| | Water | | 36.32 | | |

pTHF2000: poly(tetrahydrofuran) with molecular weight about 2000 (1950-2050)

The components of the pre-charge are charged in a reactor vessel followed by the mixture of isocyanates (Feed 1). Acetone (Feed 2) is added to the mixture and the mixture is heated to reflux until the theoretical NCO value is reached. 1,4-butanediol (Feed 3) is added and the reaction is further stirred at reflux until the desired NCO value is reached. The mixture is diluted with acetone (Feed 4). At an internal temperature of 50° C., Feed 5 is added. The mixture is dispersed by addition of water (Feed 6), followed by addition of the amines mixture and water (Feed 7). Acetone is distilled under vacuum. The polyurethane dispersion has a solid content of 45 wt %, pH of 9.5 and a viscosity: ca. 130 mPa-s (25° C.).

### Preparation of Polyacrylate Emulsion and Polyurethane Dispersion (PUD) Blends (BDs)

### Blend Example 1 (BD 1, 50:50)

50 g of PA1 and 50 g of PUD are blended in a stirred vessel and diluted with deionized water and adjusted to the desired pH with 25 wt % aqueous ammonia solution. The final blend has a solid content of 40 wt % and a pH of 8.0.

### Blend Example 2 (BD 2, 50:50)

50 g of PA2 and 50 g of PUD are blended in a stirred vessel and diluted with deionized water and adjusted to the desired pH with 25 wt % aqueous ammonia solution. The final blend has a solid content of 40 wt % and a pH of 8.0.

### Blend Example 3 (BD 3, 50:50)

50 g of PA3 and 50 g of PUD are blended in a stirred vessel and diluted with deionized water and adjusted to the desired pH with 25 wt % aqueous ammonia solution. The final blend has a solid content of 40 wt % and a pH of 8.0.

### Blend Example 4 (BD 4, 50:50)

50 g of PA4 and 50 g of PUD are blended in a stirred vessel and diluted with deionized water and adjusted to the desired pH with 25 wt % aqueous ammonia solution. The final blend has a solid content of 40 wt % and a pH of 8.0.

### Blend Example 5 (BD 5, 70:30)

70 g of PA1 and 30 g of PUD are blended in a stirred vessel and diluted with deionized water and adjusted to the desired pH with 25 wt % aqueous ammonia solution. The final blend has a solid content of 40 wt % and a pH of 8.0.

### Blend Example 6 (BD 6, 30:70)

30 g of PA1 and 70 g of PUD are blended in a stirred vessel and diluted with deionized water and adjusted to the desired pH with 25 wt-% aqueous ammonia solution. The final blend has a solid content of 40 wt % and a pH of 8.0.

### Preparation and Testing of Inks

A mixture of 46.1 g of J HPD 196 white pigment (from BASF), 50.7 g of a polyacrylate emulsion and polyurethane dispersion (PUD) blends (BDs) (e.g. BD 1 or 2 or 3 . . . ), 3.0 g of isopropanol alcohol and 0.2 g of Foamstar® SI 2292 (from BASF) were mixed together vigorously. Ink 1-6 are obtained with the respective blends (e.g. Blend example 1, Blend example 2, etc.).

The abovementioned procedure for ink preparation was repeated, but the blends were replaced with a polyacrylate dispersion or a PUD, which results an Ink 7 and Ink 8, respectively.

### Alcohol Tolerance Test on Polyacrylate Emulsion and Polyurethane Dispersion (PUD) Blends (BDs)

A polyacrylate emulsion and polyurethane dispersion (PUD) blend (BDs) was mixed with ethanol at a ratio of 1:1 (wt/wt) and stirred for 5 min at a speed of about 600 rpm. Then, the mixture was subjected to visual examination and viscosity check. The following stand has been used to assess the alcohol tolerance test performance. Viscosity change means (Viscosity_{dispersion with ethanol, stored at RT for 2 weeks}−Viscosity_{dispersion with ethanol, initial})/Viscosity_{dispersion with ethanol, initial}. Particle size change means (Particle size_{dispersion with ethanol}−Particle size_{dispersion})/Particle size_{dispersion}. The viscosity is measured with viscosity tester (from Brookfield company) and particle size is tested with Zetasizer (from Malvern company). For each dispersion, two independent tests were performed and an average rating was taken as the final rating.

Alcohol tolerance rating

| Rating | Description of rating |
|---|---|
| 5 | The dispersion is homogeneous with no particle size and viscosity change. |
| 4 | The dispersion is homogeneous, the particle size change and viscosity |
| | change less than 50%. |
| 3 | The dispersion is homogeneous, the particle size change and viscosity |
| | change is 50 to 100% |
| 2 | The dispersion has obvious gel, but most part is still flowable. |
| 1 | The dispersion has serious and obvious gel, no flowability. |

### Bond Strength Test on Polyacrylate Emulsion and Polyurethane Dispersion (PUD) Blends (BDs)

The performance was performed according to GB/T 8808-1988. The test substrate has a width of 15 mm, the peel speed is 300 mm/min and the peel angle is 90°.

For flexible package application, bond strength requirement: BOPP//PE laminate structure: 0.6-0.8N/15 mm; PET//PE laminate structure: 1.5-2.0N/15 mm.

Bond strength rating

| Rating | Description of rating |
|---|---|
| 5 | Bond strength exceed the flexible package application requirement more than |
| | 20%. |
| 4 | Bond strength can meet the flexible package application requirement |
| 3 | Bond strength below the flexible package application requirement less than |
| | 20% |
| 2 | Bond strength below the flexible package application requirement between 20% |
| | and 40% |
| 1 | Bond strength below the flexible package application requirement more than |
| | 40% |

### Resolubility Test

Drawn down the ink on PET film substrate with a width of 15 mm, after full drying, make 10 drops the polyacrylate emulsion and polyurethane dispersion (PUD) blends (BDs) on the film separately and begin to record the time after the tenth drop finished, use cotton to wipe the drops at 0.5 min, 1 min, 3 min, 5 min, 10 min, each time with two drops, and check the ink retention ratio.

Resolubility rating

| Rating | Description of rating |
|---|---|
| 5 | More than 90% of the ink was retained after wiping. |
| 4 | More than 60% and no more than 90% of the ink was retained after wiping. |
| 3 | More than 40% and no more than 60% of the ink was retained after wiping. |
| 2 | More than 10% and no more than 40% of the ink was retained after wiping. |
| 1 | No more than 10% of the ink was retained after wiping. |

The overall performance of the blends is summarized in Table 4.

TABLE 4
The ink formulation information and
the corresponding performance data

| | | Base | Base | | Alcohol | | |
|---|---|---|---|---|---|---|---|
| | Blend | Polymer | Polymer | | Toler- | Bond | Resolu- |
| | Type | Tg | Oxygen % | TAV | ance | Strength | bility |
| Ink 1 | BD 1 | −11.2 | 26.57% | 22.2 | 5 | 4 | 4.5 |
| Ink 2 | BD 2 | −11.2 | 26.57% | 41.3 | 5 | 4 | 4.5 |
| Ink 3 | BD 3 | 10.0 | 21.51% | 16.5 | 4 | 3 | 5 |
| Ink 4 | BD 4 | −8.0 | 24.09% | 66.3 | 4 | 2 | 5 |
| Ink 5 | BD 5 | −11.2 | 26.57% | 22.2 | 5 | 4.5 | 4.5 |
| Ink 6 | BD 6 | −11.2 | 26.57% | 22.2 | 5 | 3 | 3.5 |
| Ink 7 | PA 1 | −11.2 | 26.57% | 22.2 | 5 | 2.5 | 4.5 |
| Ink 8 | PUD | N.A. | N.A. | N.A. | 5 | 2.5 | 1 |

For meet an application requirement, the BDs shall have an alcohol tolerance score of at least 3 and a bond strength score of at least 3. Meanwhile, an ink shall have a resolubility score of at least 3.

It's obvious that a polyacrylate emulsion and polyurethane dispersion (PUD) blend (BD) shows better performance in alcohol tolerance and bond strength compared to a pure acrylate dispersion or a PU dispersion. And, when a BD is made into an ink, it also shows better resolubility.

1.-13. (canceled)

14. A water-based binder composition comprising:
A) a waterborne poly(meth)acrylate emulsion comprising:
(A1) An acidic polymer stabilizer with a weight average molecular weight (Mw) in the range of 4,000 to 18,000, an acid value (AV), before neutralizing, in the range of 60 to 180 and an oxygen content of at least 18 wt. %, and
(A2) A base polymer with an oxygen content of at least 12 wt. %;
wherein the acidic polymer stabilizer is present in an amount of 20 wt. % to 70 wt. %, based on the total dry weight of the waterborne poly(meth)acrylate emulsion, and the theoretical acid value (TAV) of the waterborne poly(meth)acrylate emulsion is in the range of 15 to 60, and
B) a polyurethane is made of components comprising:
(B1) at least one diisocyanate,
(B2) at least one diol having number average molecular weight of from 500 to 5000 g/mol, and
(B3) at least one mono-hydroxy functional compound having a number average molecular weight of from 500 to 5000 g/mol.

15. A water-based binder composition according to claim 14, wherein the acidic polymer stabilizer has a Mw in the range of 5,000 to 13,000.

16. A water-based binder composition according to claim 14, wherein acid value (AV) of the acidic polymer stabilizer is in the range of 65 to 180.

17. A water-based binder composition according to claim 14, wherein the acidic polymer stabilizer has an oxygen content of at least 20 wt. %.

18. A water-based binder composition according to claim 14, wherein the base polymer has a weight average molecular weight (Mw) in the range of 5,000 to 3,000,000.

19. A water-based binder composition according to claim 14, wherein the acidic polymer is present in an amount of 20 wt. % to 65 wt. %, based on the total dry weight of the waterborne poly(meth)acrylate emulsion.

20. A water-based binder composition according to claim 14, wherein the theoretical acid value (TAV) of the waterborne poly(meth)acrylate emulsion is in the range 18 to 55.

21. A water-based binder composition according to claim 14, wherein the acidic polymer is present in an amount of 20 wt. % to 65 wt. %, based on the total dry weight of the waterborne poly(meth)acrylate emulsion, and the theoretical acid value (TAV) of the waterborne poly(meth)acrylate emulsion is in the range of 18 to 55.

22. A water-based binder composition according to claim 21, wherein the acidic polymer is present in an amount of 25 wt. % to 60 wt. %, based on the total dry weight of the waterborne poly(meth)acrylate emulsion, and the theoretical acid value (TAV) of the waterborne poly(meth)acrylate emulsion is in the range of 20 to 50.

23. A water-based binder composition according to claim 14, wherein at least one of the diols is polytetrahydrofuran having a number average molecular weight of from 500 to 5000 g/mol.

24. A water-based binder composition according to claim 14, wherein the components used to make polyurethane further comprise at least one diamino acid compound.

25. A water-based binder composition according to claim 14, wherein the components used to make polyurethane further comprise at least one polyamine compound having at least two amino groups and no acid group.

26. An ink formulation comprising any of the water-based binder composition as defined in claim 14.
